(19) United States
(12) Patent Application Publication
(10) Pub. No.: US 2018/0171493 A1
(43) Pub. Date: Jun. 21, 2018

(54) COBALT MOLYBDENUM DISULFIDE SYNTHESIZED USING ALKYL-CONTAINING THIOMOLYBDATE PRECURSORS

(71) Applicant: The Board of Regents, The University of Texas System, Austin, TX (US)

(72) Inventors: Dino Villagran, El Paso, TX (US); Russell R. Chianelli, El Paso, TX (US); Yanyu Wu, El Paso, TX (US); Brenda Torres, El Paso, TX (US); Maryam Zarei-Chaleshtori, El Paso, TX (US)

(21) Appl. No.: 15/846,830

(22) Filed: Dec. 19, 2017

Related U.S. Application Data
(60) Provisional application No. 62/436,574, filed on Dec. 20, 2016.

(51) Int. Cl. C25B 11/04; B01J 27/051; B01J 35/10; C25B 1/04

(52) U.S. Cl. CPC C25B 11/0447; B01J 27/0515; C25B 11/0415; C25B 1/04; C25B 11/0405; B01J 35/1014

(57) ABSTRACT

Embodiments of the invention are directed to CoMoS2 catlaysts, methods of making and using, as well as electrodes and systems incorporating such. Synthesis of CoMoS2 catalysts using ATM treated with different amines and ammonium bromide salts including 1-dodecylamine, diethylenetriamine, tetradecyltrimethylammonium bromide and cetyltrimethylammonium bromide, to form different alky containing ATM precursors. These materials are amorphous with porous surfaces that show reasonably big surfaces area due to the number of exposed edge sites, and increased catalytic activity as electrocatalysts for hydrogen generation.

### RELATED PROVISIONAL APPLICATION

This application claims the benefit of U.S. Provisional Patent Application Ser. No. 62/436,574 filed Dec. 20, 2016, and entitled “Electrocatalytic Hydrogen Gas Generation by Cobalt Molybdenum Disulfide (CoMoS2) Synthesized Using Alkyl-Containing Thiomolybdate Precursors.”

### BACKGROUND

### 2. Field

The present disclosure relates to an improved method for synthesizing Cobalt Molybdenum disulfide (CoMoS2) using alkyl-containing thiomolybdate precursors. Still more particularly, the present disclosure relates to a method for synthesizing Cobalt Molybdenum disulfide (CoMoS₂) having a high surface area and number of catalytically active exposed edge sites.

### 2. BACKGROUND

Growing concerns about global warming and energy security demand the expansion of renewable energy sources as viable alternatives to fossil-fuel-based technologies, in conjunction with improved energy storage options. In many of the innovative approaches to address these challenges, the production of hydrogen in various (photo)-electrolysis systems plays a pivotal role. Electrocatalytic generation of molecular hydrogen through hydrogen evolution reactions (HERs) is a promising alternative for the development of clean-energy technologies. Research on HERs is focused on the implementation of robust, efficient, and cheap catalysts able to lower the activation energy required for producing hydrogen gas (Turner, Science 2004, 305(5686):972; Walter et al., Chem. Rev. 2010, 110(11):6446). Platinum metal is well suited as the most active catalyst for the electrocatalytic reduction of water to produce molecular hydrogen. This is due to the large cathodic current density generated at practically zero overpotential (Lewis and Nocera, Proc. Natl. Acad. Sci. 2006, 103(43):15729; Gray, Nat. Chem. 2009, 1(1):7; Merki and Hu, Energy Environ. Sci. 2011, 4(10):3878). However, its utilization is impeded by its high cost and rarity (Gray, Nat. Chem. 2009, 1(1):7). Thus, replacement of platinum with cost-effective and highly efficient catalysts is crucial to achieve a more sustainable way for hydrogen evolution (Du and Eisenberg, Energy Environ. Sci. 2012, 5(3):6012; Eckenhoff et al., Biochim. Biophys. Acta BBA—Bioenerg. 2013, 1827(8-9):958; Wang et al., Energy Environ. Sci. 2012, 5(5):6763).

Recently, complexes of earth-abundant metals such as Co, Mo, Ni, and Fe have emerged as alternative HER electrocatalysts to platinum (Du and Eisenberg, Energy Environ. Sci. 2012, 5(3):6012; Eckenhoff et al., Biochim. Biophys. Acta BBA—Bioenerg. 2013, 1827(8-9):95; Wang et al., Energy Environ. Sci. 2012, 5(5):6763; Callejas et al., ACS Nano 2014, 8(11):11101; Popczun et al., Angew. Chem. 2014, 126(21):5531; Hinnemann et al., J. Am. Chem. Soc. 2005, 127(15):5308). Transition metal sulfides (TMSs) have been extensively studied as catalysts for hydrodesulfurization (HDS) processes in the petroleum industry (Staszak-Jirkovský et al., Nat Mater. 2016, 15(2):197; Füchtbauer et al., Top. Catal. 2013, 57(1-4):207; Bag et al., Nat. Chem. 2009, 1(3):217; Prins et al., Catal. Rev. 1989, 31(1-2):1). Molybdenum disulfide (MoS2) is one of the most widely used industrial catalyst for HDS, and has been suggested as a possible HER catalyst through experimental and computational studies (Hinnemann et al., J. Am. Chem. Soc. 2005, 127(15):5308; Jaramillo et al., Science 2007, 317(5834):100; Karunadasa et al., Science 2012, 335(6069):698; Laursen et al., Energy Environ. Sci. 2012, 5(2):5577). However, the efficiency of MoS2 as HER electrocatalysts is hindered due to the limited number of exposed edge sites, which are important for catalytic activity (Staszak-Jirkovský et al., Nat. Mater. 2016, 15(2):197; Lukowski et al., J. Am. Chem. Soc. 2013, 135(28):10274). It has been well established that presence of Co to MoS2 will act as a promoter to increase the reactivity of MoS2 as a HDS catalyst (Popczun et al., Angew. Chem. 2014, 126(21):5531; Prins et al., Catal. Rev. 1989, 31(1-2):1; Nava et al., Catal. Lett. 86(4):257). Co—Mo—S materials are also used in the process of hydrogen production (Merki and Hu, Energy Environ. Sci. 2011, 4(10):3878).

### SUMMARY

An embodiment of the present disclosure provides a method for producing cobalt-promoted molybdenum disulfide (CoMoS₂). The method comprises alkylating ammonium thiomolybdate (ATM) with one the group consisting of C4 to C16 amines, C4 to C16 ammonium salts, and combinations thereof, to form an alkylated thiosalt precursor. The method further comprises synthesizing the CoMoS₂ from the alkylated thiosalt precursor. The CoMoS₂ has a surface area greater than about 35 square meters per gram (m²/g).

Another embodiment of the present disclosure provides a hydrogen evolution catalyst. The hydrogen evolution catalyst comprises cobalt-promoted molybdenum disulfide (CoMoS₂) having a surface area greater than about 35 square meters per gram (m²/g).

Yet another embodiment of the present disclosure provides an electrolytic cell. The electrolytic cell comprises an electrode at which a hydrogen evolution reaction occurs. The electrode comprises a metallic base cobalt-promoted molybdenum disulfide (CoMoS₂). The CoMoS₂ has a surface area greater than about 35 square meters per gram (m²/g).

A further embodiment of the present disclosure provides a method of generating hydrogen. The method comprises forming an electrolytic cell having an electrode at which a hydrogen evolution reaction occurs. The method further comprises applying a current to the cell facilitating disassociation of water and the production of hydrogen. The electrode comprises cobalt-promoted molybdenum sulfide (CoMoS₂) having a surface area greater than about 35 square meters per gram (m²/g).

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof, will best be understood by reference to the following detailed description of an illustrative embodiment of the present disclosure when read in conjunction with the accompanying drawings, wherein:

FIG. 1 is an illustration of a scanning electron micrograph of cobalt-promoted molybdenum disulfide synthesized from alkylated ammonium thiomolybdate prepared with 1-dodecylamine (DDA) in accordance with an illustrative embodiment;

FIG. 2 is an illustration of a scanning electron micrograph of cobalt-promoted molybdenum disulfide synthesized from alkylated ammonium thiomolybdate prepared with diethylenetriamine (DETA) in accordance with an illustrative embodiment;

FIG. 3 is an illustration of a scanning electron micrograph of cobalt-promoted molybdenum disulfide synthesized from alkylated ammonium thiomolybdate prepared with tetradecyltrimethylammonium (TDTA) bromide in accordance with an illustrative embodiment;

FIG. 4 is an illustration of a scanning electron micrograph of cobalt-promoted molybdenum disulfide synthesized from alkylated ammonium thiomolybdate prepared with cetyltrimethylammonium (CTA) bromide in accordance with an illustrative embodiment;

FIG. 5 is an illustration of a graph of x-ray diffraction patterns of cobalt-promoted molybdenum disulfide treated with different alkyl containing amines and ammonium salts in accordance with an illustrative embodiment;

FIG. 6 is an illustration of a graph of polarization data for electrodes prepared from cobalt-promoted molybdenum disulfide treated with different alkyl containing amines and ammonium salts in accordance with an illustrative embodiment;

FIG. 7 is an illustration of a graph of chronoamperometric responses for electrodes prepared from cobalt-promoted molybdenum disulfide treated with different alkyl containing amines and ammonium salts in accordance with an illustrative embodiment; and

FIG. 8 is an illustration of a graph of bulk electrolysis showing the accumulated charge for electrodes prepared from cobalt-promoted molybdenum disulfide treated with different alkyl containing amines and ammonium salts in accordance with an illustrative embodiment.

### DETAILED DESCRIPTION

The illustrative embodiments described herein provide for the synthesis and characterization of CoMoS₂ materials with different surface areas using different alkyl containing ammonium thiomolybdate precursors. These of CoMoS2 materials were evaluated as HER catalysts in a 0.5 M H2SO4 aqueous solution.

ATM was treated with C4 to C16 amines and C4 to C16 ammonium salts in aqueous solution to prepare the alkyl-containing ammonium thiomolybdate precursors for CoMoS2 catalysts. Specifically, ATM was treated with 1-dodecylamine (DDA), diethylenetriamine (DETA), tetradecyltrimethylammonium (TDTA) bromide, and cetyltrimethylammonium (CTA) bromide.

Electrochemical studies, including linear scanning voltammetry and bulk electrolysis, were carried out to characterize HER electrocatalytic activity of the prepared CoMoS2 materials. Long-term chronoamperometric measurements were carried out to characterize the tolerance of the prepared CoMoS2 materials to strongly acidic media.

Synthesis of CoMoS2 catalysts using ATM form different alkyl-containing ATM precursors when treated with different amines and ammonium bromide salts including 1-dodecylamine, diethylenetriamine, tetradecyltrimethylammonium bromide, and cetyltrimethylammoniumb bromide. These materials are amorphous and with porous surfaces that show reasonable big surface area. Electrochemical studies along with hydrogen gas analysis in 0.5 M H₂SO₄ aqueous media indicate that these materials are active electrocatalysts for hydrogen generation and show good stability in acid during long-term electrolysis.

### Examples

### Sample Preparation

Preparation of alky-containing ATM was followed by a simple synthetic technique in aqueous solution to form the different CoMoS₂ materials. This method involves a one-step substitution of the NH₄⁺ from ATM by the alkyl containing amines or ammonium salts.

ATM (5.0 g, 19.2 mmol) was dissolved in 10 mL deionized water (DIW). A solution of 2 equivalents (38.4 mmol) amine or ammonium bromide salt in 50 mL DIW was added to form a black slurry. A solution of CoCl₂ (2.5 g, 19.2 mmol) in 10 ml DIW was added to the reaction mixture. The reactor vessel was then heated at 300° C. for 2 hours.

It should be noted that the amines were evaporated off during the reaction which built up the pressure. Thus, pressure was held constant at 1300 Psi to prevent an explosion. After completion, the resultant products were filtered and washed with water and isopropyl alcohol and then dried under reduced pressure.

### Results

### Surface Area Analyses

All the CoMoS₂ samples were characterized by means of Brunauer-Emmett-Teller (BET) analyses. Surface area analyses were obtained on a Micromeritics Accelerated Surface Area and Porosity System (ASAP 2020).

TABLE 1

| | | Specific |
|---|---|---|
| | | surface area |
| | | (m²/g) of |
| Sample | Amine/Ammonium Salt | CoMoS₂ |
| 1 | 1-Dodecylamine | 69 |
| 2 | Diethylenetriamine | 43 |
| 3 | Tetradecyltrimethylammonium | 63 |
| | bromide | |
| 4 | Cetyltrimethylammonium bromide | 56 |

### SEM Characterization

All CoMoS₂ samples were characterized by means of scanning electron microscopy (SEM) to reveal the morphology of the CoMoS₂ using different alkyl-containing ATM precursors. SEM experiments were performed using a Hitachi S-4800 SEM instrument.

The surface areas of the synthesized CoMoS₂ samples range from 43-69 m²/g (Table 1). CoMoS2 prepared from DDA (Sample 1) shows the highest surface area while CoMoS2 prepared from DDA (DETA) exhibits the lowest.

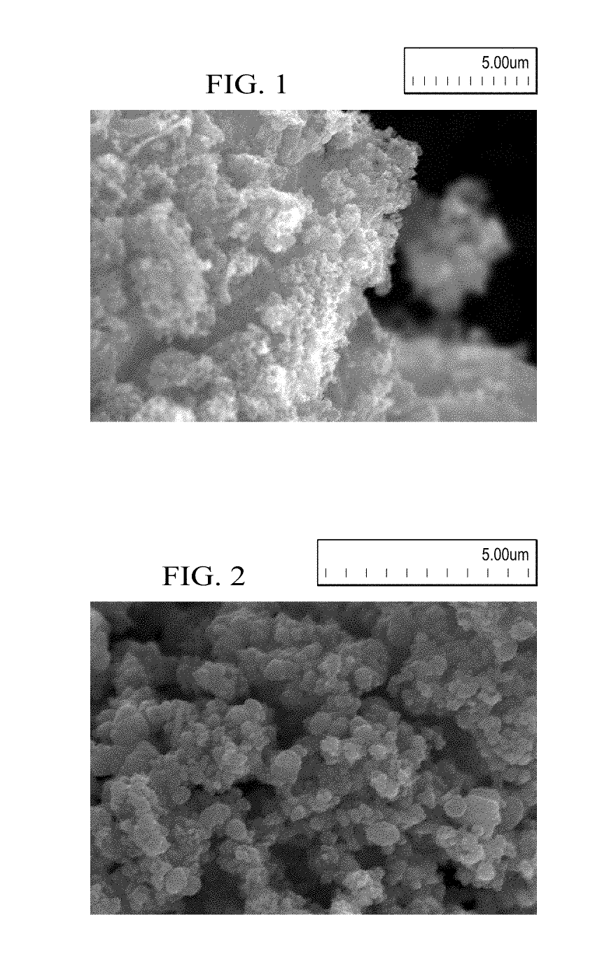

Scanning electron micrographs of CoMoS₂ catalysts for Samples 1 and 2 are shown in FIGS. 1 and 2, respectively. As is shown in FIGS. 1 and 2, CoMoS₂ samples prepared from the C4 to C16 amines according to Samples 1 and 2 appear to illustrate CoMoS2 particles having irregular, spherical shapes.

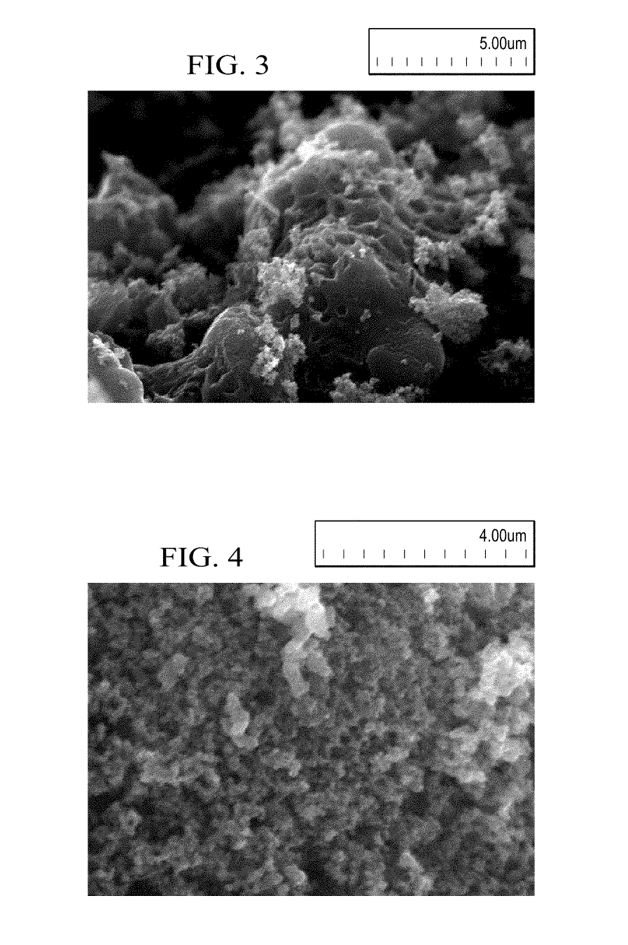

Scanning electron micrographs of CoMoS₂ catalysts for Samples 3 and 4 are shown in FIGS. 3 and 4, respectively. As is shown in FIGS. 3 and 4, CoMoS₂ Samples prepared from the C4 to C16 ammonium salts according to Samples 3 and 4 appear to illustrate CoMoS2 particles having a sponge-like, porous surface. This morphology can be attributed to the pores left after the decomposition of amines in high temperature during the synthesis.

### XRD Characterization

All CoMoS2 samples were characterized by means of X-Ray Diffraction. XRD data were obtained on a Bruker D8 Discover X-ray Diffractometer.

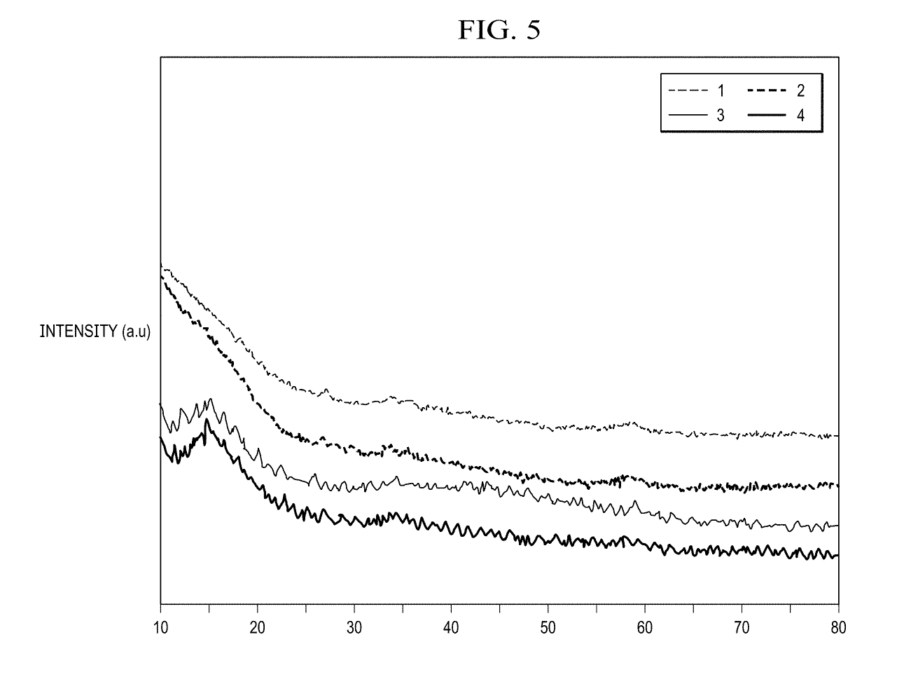

As shown in FIG. 5, XRD patterns for all CoMoS₂ samples treated with different amines exhibit weak and disperse diffraction peaks, indicating the poor crystalline characteristic of Co-promoted MoS2. The diffraction peak at 2θ=14.4° which is characteristic of the (0 0 2) basal planes of crystalline MoS2, is broadened for Samples 3 and 4 and absent in the case of Samples 1 and 2. This results from the carbon after decomposition of the amines, which is similar to the dispersion of carbon-supported MoS2 catalysts.

### Examples

### Electrode & Electrochemical Cell Preparation

Catalysts CoMoS₂ prepared according to each of Samples 1-4 were coated on fluorine-doped tin oxide (FTO) glass substrates with silver paste prior to the electrochemical measurements and employed as working electrodes in electrochemical studies.

10 mg CoMoS₂ was dispersed in 10 mL ethanol and ultrasonicated for 30 minutes to generate a homogenous suspension. FTO glass was cleaned with water and acetone before a thin layer of silver paste was coated on top of the active side of the FTO glass with an area of 1 cm². 0.5 mL of the prepared suspension containing the CoMoS₂ sample material was spin-coated on the silver paste using a spin coater. (Spin rate: 1000 rpm; Time: 1 minute). The CoMoS₂/FTO substrates were then allowed to dry prior to use.

Bulk electrolysis and chronoamperometric measurements were performed in a custom-built two-compartment gas-tight electrochemical cell under argon atmosphere. The working and counter electrodes of the two-compartments are separated through a fine glass frit.

A first compartment of the cell contains: (i) CoMoS₂/FTO working electrode (1 cm²); (ii) saturated calomel electrode (SCE) reference electrode; and (iii) gas inlet and gas outlet. The electrolyte solution in the first compartment was kept stirring to remove the in situ-generated H₂ bubbles. The second compartment of the cell contains: (i) a platinum mesh auxiliary counter electrode; and (ii) a gas outlet.

### Electrochemical Measurements

Electrochemical measurements were obtained using a CHI760D potentiostat. The potentials displayed were referred to reversible hydrogen electrode (RHE). All potentials obtained referenced to SCE were calibrated with respect to reversible hydrogen electrode (RHE). A 2 mm diameter platinum working electrode was used for cyclic voltammogram in 0.5 M H₂SO₄ solution at a scan rate of 50 mV/s. The potential at which the cathodic current increase was constantly observed to be −0.27 V vs. SCE. Thus, the potentials obtained using a SCE reference electrode were added by +0.27 V in order to be referred to RHE.

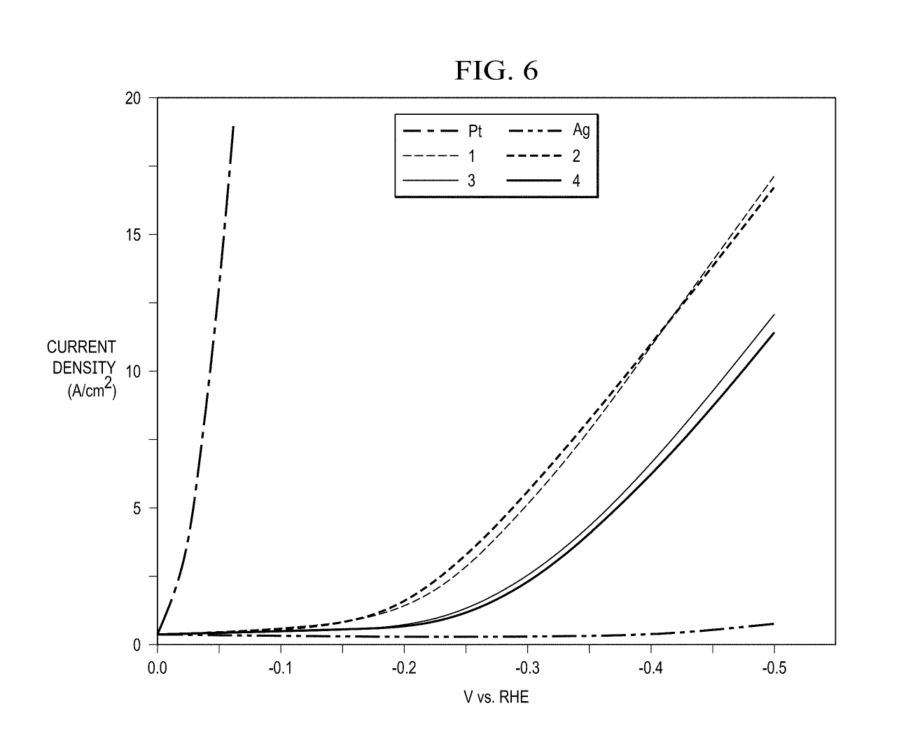

The electrocatalytic HER behaviours of the prepared CoMoS₂ samples were studied in a 0.5 M H₂SO₄ aqueous solution. FIG. 6 shows the HER polarization curves when using the prepared CoMoS₂/silver FTO working electrodes with a linear scanning voltammetry from 0 V to −0.5 V vs. RHE and two control working electrodes as comparison. Samples 1, 2, 3 and 4 show the onset overpotential where the increase of cathodic catalytic current is observed, are −0.184, −0.180, −0.208 and −0.207 V vs. RHE, respectively.

TABLE 2

| | Overpotential | Current Density @ |
|---|---|---|
| | Onset vs. | −0.5 V vs RHE |
| Sample | RHE (V) | (mA/cm²) |
| 1 | −0.184 V | 17.2 |
| 2 | −0.180 V | 16.7 |
| 3 | −0.208 V | 12.1 |
| 4 | −0.207 V | 11.5 |

A control working electrode of platinum metal was used as a benchmark electrocatalyst for hydrogen generation. Platinum shows an immediate enhancement of catalytic current at 0 V vs. RHE. A blank FTO glass coated with silver paste, which is the substrate for preparing the CoMoS₂ electrode, was also tested, and it shows negligible current increase at potentials between 0 V to −0.5 V vs RHE. The corresponding current densities generated at −0.5 V vs. RHE are 17.2, 16.7, 12.1, 11.5, mA/cm².

### Chronoamperometric Response

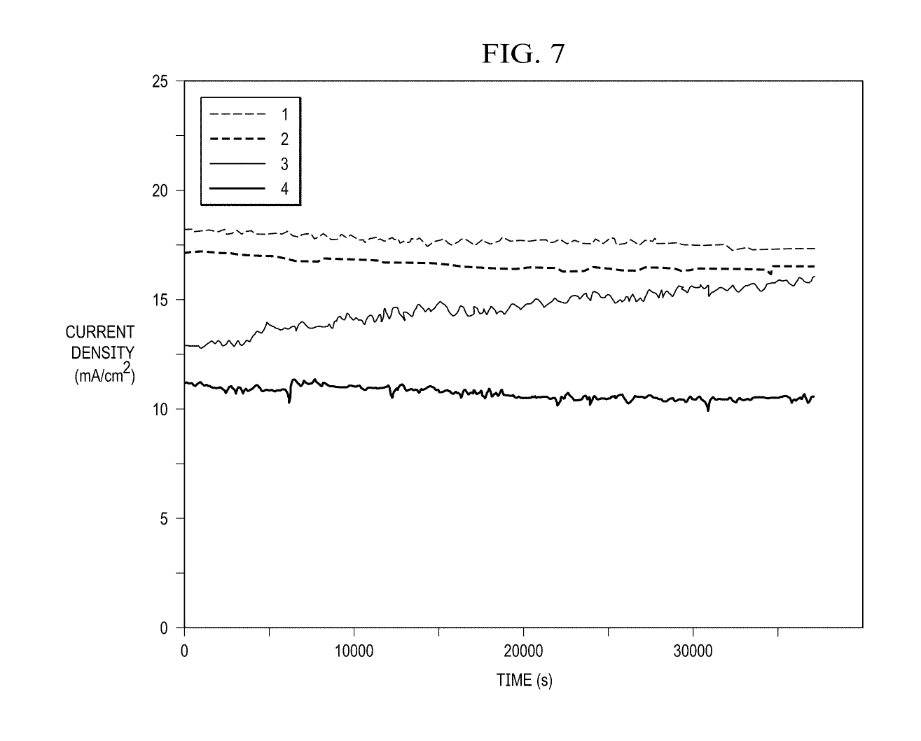

FIG. 7 is a graph of chronoamperometric responses (j˜t) using samples 1-4/silver/FTO working electrodes in 0.5 M H2SO4 for 10 hours at −0.5 V vs. RHE. Long term chronoamperometric measurements were performed using the prepared CoMoS₂/silver/FTO working electrodes in 0.5 M H₂SO₄ electrolyte at a constant potential of −0.5 V vs. RHE for 10 hours' continuous operation. Each of the prepared CoMoS₂ samples showed good durability in strong acid. As is illustrated in FIG. 7, Samples 1, 2, and 4 show negligible current density decrease while Sample 3 exhibits slightly increased current density.

### Bulk Electrolysis

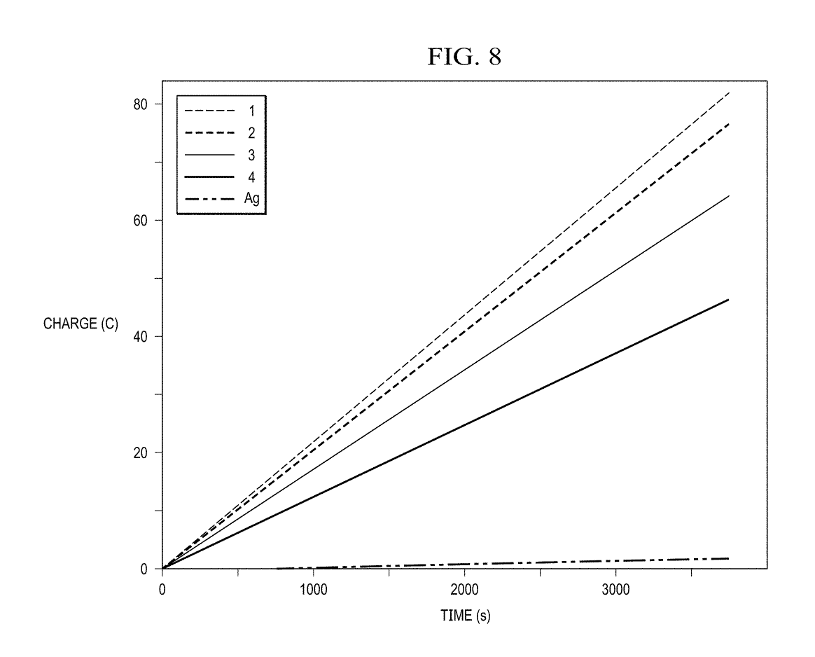

FIG. 8 is a graph of bulk electrolysis of Samples 1-4 and blank silver-coated FTO glass in 0.5 M H₂SO₄ in water @ applied potential: −0.5 V vs RHE.

To quantify the hydrogen gas generated, bulk electrolysis along with gas detection was performed. FIG. 8 shows the accumulated charge at constant controlled potential of −0.5 V vs. RHE in a 0.5 M aqueous H₂SO₄ solution of the four catalysts and pure silver-coated FTO glass as blank for an hour.

TABLE 3

| | Charge Passage @ |
|---|---|
| Sample | −0.5 V vs RHE (C) |
| 1 | 81.7 |
| 2 | 76.6 |
| 3 | 64.2 |
| 4 | 46.6 |

The passages of charge of Samples 1, 2, 3, and 4 for one hour are 81.7, 76.6, 64.2, and 46.6 C, respectively. The blank silver-coated FTO glass generates negligible charge at the same potential. The amount of H2 gas evolved shows between 98% to 100% faradaic yield, which implies a quantitative faradaic yield for hydrogen generation. The blank silver-coated FTO glass shows no H2 generation at the same potential.

Electrochemical studies of these four CoMoS₂ HER catalysts synthesized using different alkyl-containing ammonium thiomolybdate precursors show different electrocatalytic behaviors. Samples 3 and 4, which are synthesized using ATM treating with amines with longer carbon chains and more branches as compared to Samples 1 and 2, are less active CoMoS₂ HER catalysts with higher overpotential and less current density at the same potential.

The description of the different illustrative embodiments has been presented for purposes of illustration and description and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A hydrogen evolution catalyst comprising:
cobalt-promoted molybdenum disulfide (CoMoS₂) having a surface area greater than about 35 square meters per gram (m²/g).

2. The hydrogen evolution catalyst of claim 1, wherein the CoMoS₂ has a surface area of from about 35 m²/g to about 100 m²/g, preferably from about 38 m²/g to about 90 m²/g, more preferably from about 41 m²/g to about 80 m²/g, and most preferably from about 43 m²/g to about 69 m²/g.

3. The hydrogen evolution catalyst of claim 1, wherein the CoMoS₂ is synthesized from an alkylated thiosalt precursor.

4. The hydrogen evolution catalyst of claim 3, wherein the alkylated thiosalt precursor is ammonium thiomolybdate (ATM) alkylated by a reaction with one of the group consisting of C4 to C16 amines, C4 to C16 ammonium salts, and combinations thereof.

5. The hydrogen evolution catalyst of claim 4, wherein the amine is diethylenetriamine (DETA) or 1-dodecylamine (DDA).

6. The hydrogen evolution catalyst of claim 4, wherein the ammonium salt is tetradecyltrimethylammonium (TDTA) bromide or cetyltrimethylammonium (CTA) bromide.

7. An electrolytic cell comprising:
an electrode at which a hydrogen evolution reaction occurs, the electrode comprising:
a metallic base; and
cobalt-promoted molybdenum disulfide (CoMoS₂), wherein the CoMoS₂ has a surface area greater than about 35 square meters per gram (m²/g).

8. The electrolytic cell of claim 7, wherein the CoMoS₂ has a surface area of from about 35 m²/g to about 100 m²/g, preferably from about 38 m²/g to about 90 m²/g, more preferably from about 41 m²/g to about 80 m²/g, and most preferably from about 43 m²/g to about 69 m²/g.

9. The electrolytic cell of claim 7, wherein:
the metallic base is selected from the group consisting of a metal base, a metal oxide base, a mixed metal oxide base, and combinations thereof; and
the CoMoS₂ forms a coating on the metallic base.

10. The electrolytic cell of claim 9, wherein the metal oxide base is a tin oxide base.

11. The electrolytic cell of claim 9, wherein the metal base is platinum base.

12. The electrolytic cell of claim 7, wherein the CoMoS₂ is synthesized from an alkylated thiosalt precursor.

13. The electrolytic cell of claim 12, wherein the alkylated thiosalt precursor is ammonium thiomolybdate (ATM) alkylated by a reaction with one of the group consisting of C4 to C16 amines, C4 to C16 ammonium salts, and combinations thereof.

14. The electrolytic cell of claim 13, wherein the amine is diethylenetriamine (DETA) or 1-dodecylamine (DDA).

15. The electrolytic cell of claim 13, wherein the ammonium salt is tetradecyltrimethylammonium (TDTA) bromide or cetyltrimethylammonium (CTA) bromide.

16. A method of generating hydrogen comprising:
forming an electrolytic cell, the electrolytic cell having an electrode at which a hydrogen evolution reaction occurs; and
applying a current to the cell facilitating disassociation of water and the production of hydrogen;
wherein the electrode comprises cobalt-promoted molybdenum sulfide (CoMoS₂) having a surface area greater than about 35 square meters per gram (m²/g).

17. The method of claim 16, wherein the CoMoS₂ has a surface area of from about 35 m²/g to about 100 m²/g, preferably from about 38 m²/g to about 90 m²/g, more preferably from about 41 m²/g to about 80 m²/g, and most preferably from about 43 m²/g to about 69 m²/g.

18. The method of claim 16, wherein the CoMoS₂ is synthesized from an alkylated thiosalt precursor.

19. The method of claim 18, wherein the alkylated thiosalt precursor is ammonium thiomolybdate (ATM) alkylated by a reaction with one of the group consisting of C4 to C16 amines, C4 to C16 ammonium salts, and combinations thereof.

20. The method of claim 19, wherein the amine is diethylenetriamine (DETA) or 1-dodecylamine (DDA).

21. The method of claim 20, wherein the ammonium salt is tetradecyltrimethylammonium (TDTA) bromide or cetyltrimethylammonium (CTA) bromide.

22. A method for producing cobalt-promoted molybdenum disulfide (CoMoS₂), comprising:
alkylating ammonium thiomolybdate (ATM) with one the group consisting of C4 to C16 amines, C4 to C16 ammonium salts, and combinations thereof, to form an alkylated thiosalt precursor; and
synthesizing the CoMoS₂ from the alkylated thiosalt precursor, wherein the CoMoS₂ has a surface area greater than about 35 square meters per gram (m²/g).

23. The method of claim 22, wherein the alkylating and synthesizing steps further comprise:
contacting an aqueous solution of ammonium thiomolybdate (ATM) with a second aqueous solution of the of C4 to C16 amines, C4 to C16 ammonium salts, and combinations thereof, forming a reaction mixture;
adding a cobalt chloride solution to the reaction mixture; and
reacting the reaction mixture at constant heat and pressure to form the CoMoS₂.

24. The method of claim 23, wherein reacting the reaction mixture further comprises:
decomposing the C4 to C16 amines from the alkylated thiosalt precursor to form the CoMoS₂ having a surface area greater than about 35 square meters per gram (m²/g); and
evaporating the C4 to C16 amines from the reaction mixture under constant pressure.

25. The method of claim 22, wherein the alkylated thiosalt precursor is ammonium thiomolybdate (ATM) alkylated by a reaction with one of the group consisting of C4 to C16 amines, C4 to C16 ammonium salts, and combinations thereof.

26. The method of claim 25, wherein the amine is diethylenetriamine (DETA) or 1-dodecylamine (DDA).

27. The method of claim 25, wherein the ammonium salt is tetradecyltrimethylammonium (TDTA) bromide or cetyltrimethylammonium (CTA) bromide.
